(19) United States
(12) Patent Application Publication
(10) Pub. No.: US 2019/0068033 A1
(43) Pub. Date: Feb. 28, 2019

(54) BRUSHED MOTOR FOR VEHICLE AND METHOD FOR MANUFACTURING THE SAME

(71) Applicant: Mitsubishi Electric Corporation, Tokyo (JP)

(72) Inventor: Takashi GOTO, Tokyo (JP)

(73) Assignee: Mitsubishi Electric Corporation, Tokyo (JP)

(21) Appl. No.: 16/079,904

(22) PCT Filed: Mar. 18, 2016
(86) PCT No.: PCT/JP2016/058747

§ 371 Date: Aug. 24, 2018

(51) Int. Cl. H02K 13/10; H02K 15/12

(52) U.S. Cl. CPC H02K 13/105; H01R 39/32; H02K 15/12

(57) ABSTRACT

A brushed motor includes a shaft inserted in a cylindrical stator, a rotor including a core provided on an outer circumference of the shaft to face the stator and a coil having a distributed winding structure wound around teeth of the core, a commutator provided on one end of the shaft, and electrically connected with the coil by a wire drawn from coil end parts of the coil, a resin molded part covering the coil end parts and a hooking portions for the wire of the commutator, and a brush in contact with an outer circumference of the commutator. A width of a gap between the resin molded part and the brush is set to a value larger than a scattering distance of a spark generated between the commutator and the brush.

### TECHNICAL FIELD

The present invention relates to a brushed motor for a vehicle and a method for manufacturing the brushed motor.

### BACKGROUND ART

Conventionally, a rotor of a brushed motor includes a core made of steel lamination, and a coil formed by wires wound around teeth of the core. There are some coil winding methods such as a method of winding a wire concentratedly around each of the teeth, which is so-called “concentrated winding,” or a method of winding a wire over a plurality of teeth, which is so-called “distributed winding.”

In a brushed motor, when commutator pieces in contact with brushes are switched by rotation of a rotor, sparks are generated between the commutator and the brushes. In addition, the sparks cause electrical noise. Generally, since sparks are easily generated in a brushed motor having a coil of the concentrated winding structure, a snubber circuit is provided so as to reduce electrical noise. A snubber circuit is formed by circuit elements such as a resistor and a capacitor.

In a brushed motor for a vehicle, however, it is difficult to provide a snubber circuit since the environmental temperature during use may exceed the upper temperature limit of capacitors. Thus, in a brushed motor for a vehicle, a coil having a distributed winding structure is preferably used, in which generation of sparks is suppressed and electrical noise is reduced without requiring a snubber circuit.

However, a coil having a distributed winding structure is disadvantageous because a wire is wound over a plurality of teeth so that collapse of winding occurs at a coil end part. Further, the wires rub against each other due to the collapse of winding, which is disadvantageous in that coating materials of the wires will be worn, which causes electrical short circuit of the coil. In particular, in a brushed motor for a vehicle, collapse of winding may easily occur caused by vibration due to driving of an engine, vibration of a vehicle body while the vehicle is traveling, and the like.

As a method for preventing such collapse of winding, a method of molding a coil end part with resin is considered. Patent Literature 1 discloses a series motor in which a coil end part is molded with resin.

### CITATION LIST

### Patent Literature

### Patent Literature 1: JP H07-123642 A (JP1995-123642A)

### SUMMARY OF INVENTION

### Technical Problem

In a brushed motor, even in a case where a coil of a distributed winding structure is used, it is difficult to completely prevent generation of sparks. A brushed motor in which a coil end part is molded with resin is disadvantageous in that sparks generated continuously reach the resin molded part, and the resin molded part is melted and deteriorated by high temperature. As a result, the mechanical strength of the resin molded part is lowered.

The present invention has been made to solve the above problem, and an object thereof is to prevent melting and deterioration of a resin molded part due to heat of sparks in a brushed motor for a vehicle in which a coil having a distributed winding structure is used in a rotor.

### Solution to Problem

A brushed motor for a vehicle according to the present invention includes: a shaft inserted in a stator having a cylindrical shape; a rotor including a core provided on an outer circumference of the shaft to face the stator, and a coil having a distributed winding structure wound around teeth of the core; a commutator provided on one end of the shaft, and electrically connected with the coil by a wire drawn from coil end parts of the coil; a resin molded part covering the coil end parts and a hooking portion for the wire of the commutator; and a brush being in contact with an outer circumference of the commutator. A width of a gap between the resin molded part and the brush is set to a value larger than a scattering distance of a spark generated between the commutator and the brush.

### Advantageous Effects of Invention

According to the present invention, melting and deterioration of a resin molded part due to heat of sparks are prevented in a brushed motor for a vehicle, the brushed motor using a coil of a distributed winding structure.

### BRIEF DESCRIPTION OF DRAWINGS

FIG. 1 is a cross-sectional view illustrating a main part of a brushed motor according to a first embodiment of the present invention;

FIG. 2 is a perspective view illustrating a shaft, a rotor, a commutator, and a resin molded part according to the first embodiment of the present invention;

FIG. 3 is a perspective view illustrating a state after integral assembly of the shaft, the rotor, and the commutator and before fixing of hooking portions by fusing according to the first embodiment of the present invention;

FIG. 4 is an enlarged view of a region including the commutator, brushes, and the resin molded part illustrated in FIG. 1;

FIG. 5 is an explanatory drawing illustrating wear debris and sparks generated in the brushed motor according to the first embodiment of the present invention;

FIG. 6 is a cross-sectional view illustrating a main part of a rotating member according to the first embodiment of the present invention;

FIG. 7 is an explanatory view illustrating a state in which the rotating member illustrated in FIG. 6 is placed in a metal mold;

FIG. 8 is a cross-sectional view illustrating a main part of another brushed motor according to the first embodiment of the present invention;

FIG. 9 is an explanatory view illustrating a state in which another rotating member according to the first embodiment of the present invention is placed in a metal mold;

FIG. 10 is a cross-sectional view illustrating a main part of another brushed motor according to the first embodiment of the present invention;

FIG. 11 is a cross-sectional view illustrating a main part of another brushed motor according to the first embodiment of the present invention; and

FIG. 12 is a cross-sectional view illustrating a main part of another brushed motor according to the first embodiment of the present invention.

### DESCRIPTION OF EMBODIMENTS

Some embodiments for carrying out the present invention will now be described with reference to the accompanying drawings for explaining the invention in more detail.

### First Embodiment

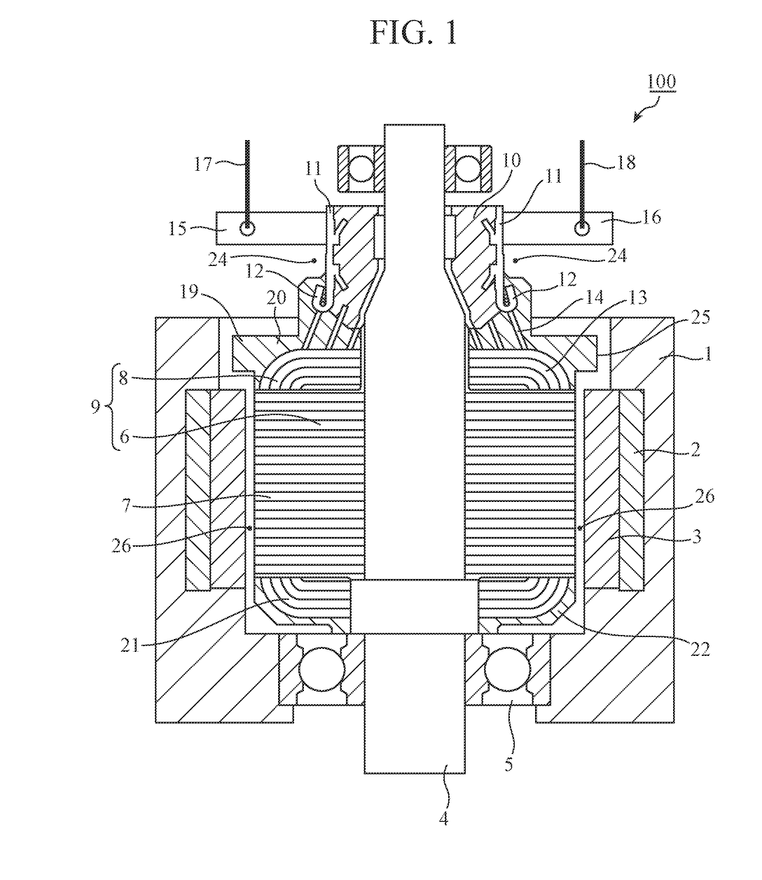

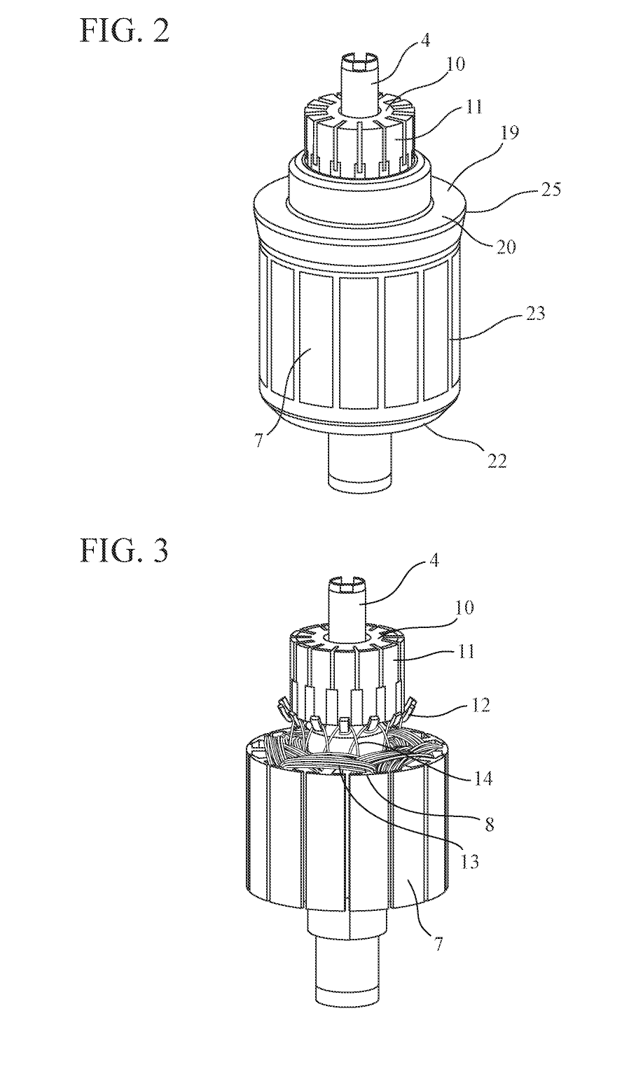

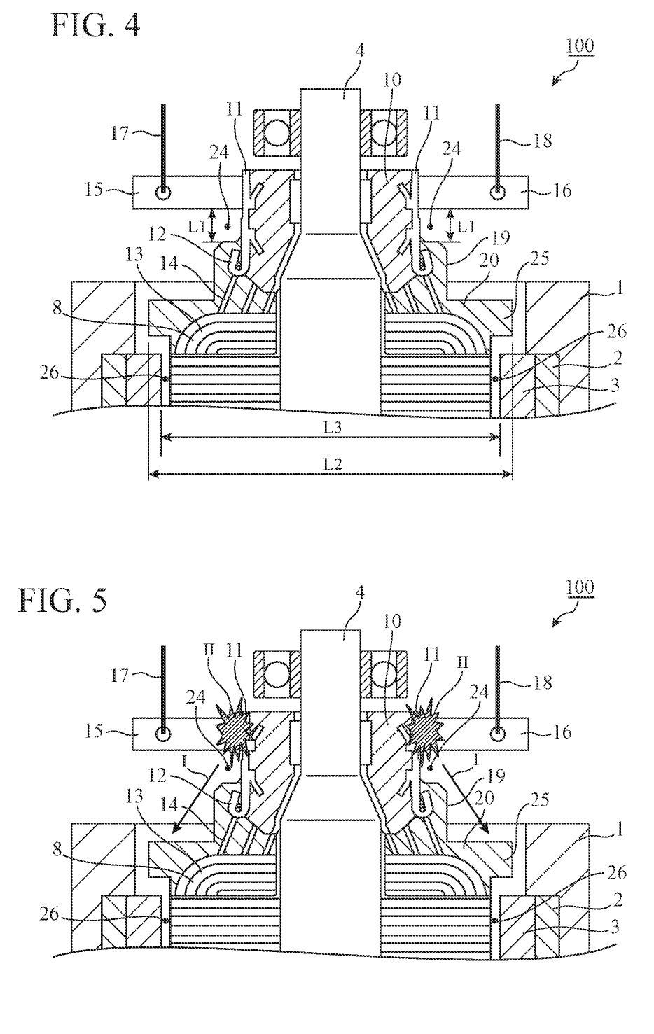

FIG. 1 is a cross-sectional view illustrating a main part of a brushed motor according to a first embodiment of the present invention. FIG. 2 is a perspective view illustrating a shaft, a rotor, a commutator, and a resin molded part according to the first embodiment of the present invention. FIG. 3 is a perspective view illustrating a state after assembly of the shaft, the rotor, and the commutator to form an integrated member before fixing of hooking portions by fusing according to the first embodiment of the present invention. FIG. 4 is an enlarged view of a region including the commutator, brushes, and the resin molded part illustrated in FIG. 1. A brushed motor 100 according to the first embodiment will be described with reference to FIGS. 1 to 4.

In the figures, a reference numeral 1 represents a stator. The stator 1 has an approximately cylindrical shape and is provided with a yoke 2 and a magnet 3 on an inner circumference thereof. The yoke 2 is made of iron, for example. The magnet 3 is a permanent magnet formed by material such as a ferrite magnet, for example.

A shaft 4 having a substantially rod shape extends through the stator 1. The shaft 4 is supported by a bearing 5 such as a ball bearing to be rotatable relative to the stator 1.

A core 6 is provided around an outer circumference of the shaft 4. The core 6 is made of steel lamination, for example, and positioned to face the magnet 3 of the stator 1. The core 6 has a plurality of teeth 7 arranged to be side by side along an outer circumference of the core 6. Each of the teeth 7 has such a shape that the longitudinal direction thereof extends along the axial direction of the shaft 4.

Wires are wound around the teeth 7. The wires are enameled wires, for example. The wires wound around the teeth 7 form a coil 8 of a distributed winding structure. The core 6 and the coil 8 form a rotor 9. When the coil 8 is energized, the rotor 9 rotates integrally with the shaft 4 relative to the stator 1.

A commutator 10 is provided on one end of the shaft 4. The commutator 10 has a substantially cylindrical external shape and has a plurality of commutator pieces 11 arranged to be side by side along an outer circumference thereof. Each of the commutator pieces 11 has such a shape that the longitudinal direction thereof extends along the axial direction of the shaft 4, and has a hooking portion 12 on an end of the side of the rotor 9. The hooking portions 12 are fixed by fusing in a state in which wires (hereinafter referred to as “crossover wires”) 14 drawn from a coil end part 13 of the coil 8 of the side of the commutator 10 are hung on the hooking portion 12. In this manner, the commutator 10 and the coil 8 are electrically connected with each other. A plurality of wires are fixed to each of the hooking portions 12 by fusing. When the coil 8 is energized, the commutator 10 rotates integrally with the shaft 4 and the rotor 9 relative to the stator 1.

A pair of brushes 15 and 16 are in slidable contact with the outer circumference of the commutator 10. A power supply terminal 17 for a positive electrode is attached to one brush 15, and a power supply terminal 18 for a negative electrode is attached to the other brush 16.

Note that the rotor 9 is molded with resin. A resin molded part 19 has a first portion 20 covering the coil end part 13 of the coil 8 on the side of the commutator 10, the crossover wires 14, and the hooking portions 12. Further, the resin molded part 19 has a second portion 22 covering the other coil end part 21 of the coil 8. Thus, the coil end parts 13 and 21 and the hooking portions 12 are entirely covered with the resin molded part 19. Moreover, the resin molded part 19 has a third portion 23 filling spaces between adjacent teeth 7 and connected with the first portion 20 and the second portion 22.

A gap 24 is provided between a portion of the first portion 20 closest to the brushes 15 and 16, that is, a portion covering the hooking portions 12 and the brushes 15 and 16. The gap 24 has a width L1 set to a value larger than the scattering distances of sparks generated between the commutator 10 and the brushes 15 and 16.

Generally, the scattering distance of a spark varies depending on the size of the brushed motor 100, the amount of the power supplied for energization, and the like, and varies from one spark to another. “A value larger than the scattering distances of sparks” may be any value that is sufficiently large to prevent melting and deterioration of the first portion 20 due to the heat of sparks, which is, for example, a value larger than about 80% of the maximum value of the spark scattering distances estimated depending on the size of the brushed motor 100, the amount of the power supplied for energization, and the like. An example of a specific numerical value of the width L1 of the gap 24 is a value equal to or larger than 1 millimeter (mm).

The first portion 20 has a flange 25 facing the brushes 15 and 16. The flange 25 has a diameter L2 set to a value larger than the inner diameter of the stator 1 (specifically, the inner diameter of the magnet 3 provided on the inner circumference of the stator 1) L3.

An outer circumferential surface of the third portion 23 is continuous with outer circumferential surfaces of the teeth 7. As a result, the rotor 9 after being molded has a substantially cylindrical external shape, with a gap 26 formed between the outer circumference of the teeth 7 and the third portion 23, and the inner circumference of the stator 1. The main part of the brushed motor 100 is formed as described above.

Next, operation and effects of the brushed motor 100 will be explained with reference to FIG. 5. The brushed motor 100 is mounted on a vehicle, and positioned so that the axis of the shaft 4 extends along the vertical direction or arranged to be inclined to the vertical direction. The commutator 10 is located at a position upper than the rotor 9.

When a power supply, which is not illustrated, applies a voltage across the power supply terminals 17 and 18, a current flows to the brushes 15 and 16, and the coil 8 is energized via the commutator 10. The energization of the coil 8 causes the rotor 9, which is formed by the core 6 and the coil 8, to function as an electromagnet, and the magnetic force between the magnet 3 and the rotor 9 rotates the rotor 9 relative to the stator 1. The commutator 10 rotates integrally with the rotor 9, which switches the commutator pieces 11 being in contact with the brushes 15 and 16. Consequently, the direction of the current flowing through the coil 8 is switched, so that the rotor 9 rotates continuously.

In this process, wear debris is produced by sliding movement of the commutator 10 and the brushes 15 and 16 relative to each other. The produced wear debris moves toward the rotor 9 as shown by the arrows I in FIG. 5. A conventional brushed motor having no flange 25 or having a flange 25 with a small diameter L2 is disadvantageous in that the wear debris enters the gap 26 between the rotor 9 and the stator 1 and invades into the bearing 5 through the gap 26, which makes the bearing 5 defective. In contrast, in the brushed motor 100 of the first embodiment, the resin molded part 19 has the flange 25, whose diameter L2 is set to a value larger than the inner diameter L3 of the stator 1. As a result, wear debris is prevented from entering the gap 26 and thus failure of the bearing 5 can be prevented.

Further, when the commutator piece 11 in contact with the brushes 15 and 16 is switched, sparks II are generated between the commutator 10 and the brushes 15 and 16. A conventional brushed motor having no gap 24 or having a gap 24 with a small width L1 is disadvantageous in that scattered sparks II generated continuously reach the resin molded part 19, and the resin molded part 19 is melted and deteriorated by high temperature. In contrast, in the brushed motor 100 of the first embodiment, the gap 24 exists between the resin molded part 19 and the brushes 15 and 16, and the width L1 of the gap 24 is set to a value larger than the scattering distances of the sparks II. As a result of this configuration, the resin molded part 19 is prevented from being melted and deteriorated by the heat of the sparks II, and thus deterioration of mechanical strength of the resin molded part 19 can be prevented.

In the brushed motor 100 of the first embodiment, the coil end parts 13 and 21 are entirely covered with the resin molded part 19. Due to such a configuration, collapse of winding at the coil end parts 13 and 21 can be prevented. In addition, coating materials of wires do not wear owing to collapse of winding, so that electrical short circuit of the coil 8 can be prevented.

Further, in the brushed motor 100 of the first embodiment, the hooking portions 12 are entirely covered with the resin molded part 19. In general, at hooking portions of a brushed motor including a coil of a distributed winding structure, a plurality of wires are pressed flat and fused, and thus are low in strength and easily disconnected by vibration. In contrast, since the hooking portions 12 are entirely covered with the resin molded part 19, the wires at the hooking portions 12 are fixed, so that disconnection due to vibration can be prevented.

Moreover, the resin molded part 19 has the third portion 23 filling each of the spaces between adjacent teeth 7 and connected with the first portion 20 and the second portion 22. The third portion 23 increases the rigidity of the rotor 9, so that deformation of the rotor 9 due to vibration can be prevented. As a result, loading on the shaft 4 and disconnection of the crossover wires 14 due to deformation can be prevented.

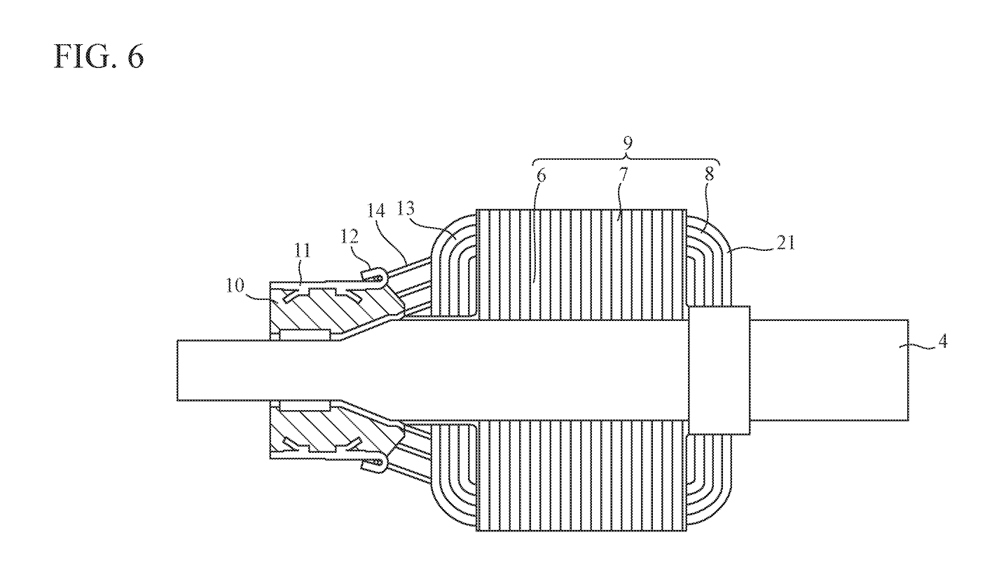

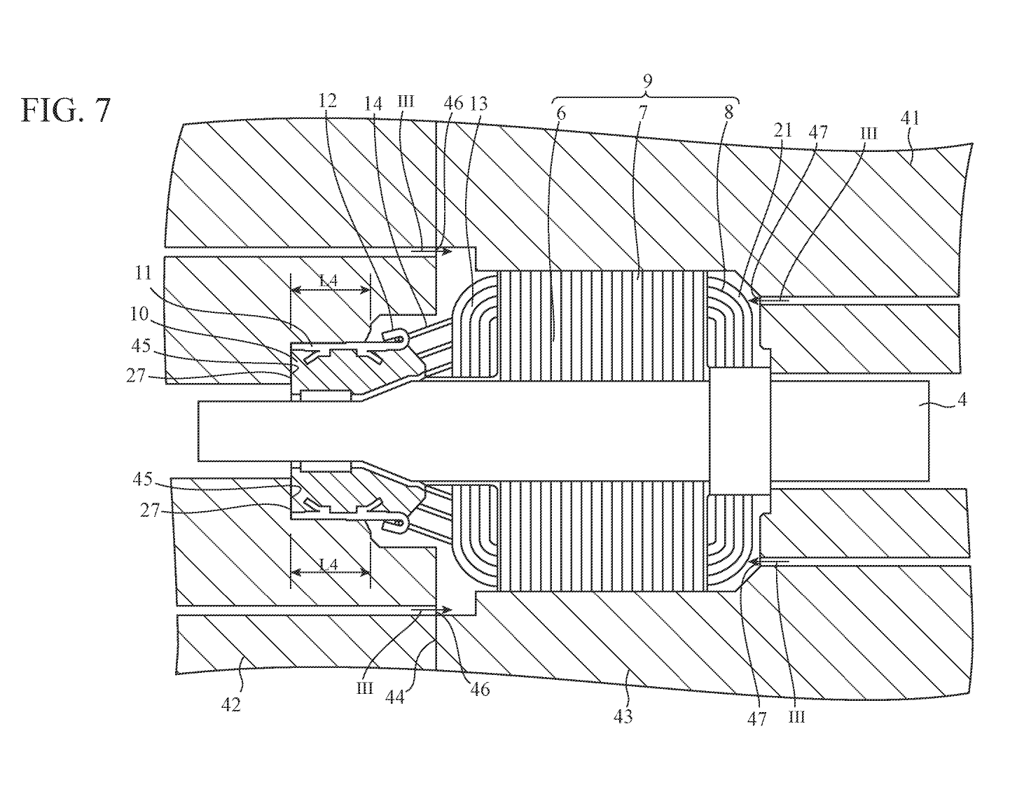

Next, a manufacturing method of the brushed motor 100 will be explained with reference to FIGS. 6 and 7 focusing on a method of molding the resin molded part 19. The resin molded part 19 is molded by injection molding using a metal mold 41.

First, as illustrated in FIG. 6, a member (hereinafter referred to as a “rotating member”) formed by integrating the shaft 4, the rotor 9, and the commutator 10 and fixing the hooking portions 12 by fusing is produced.

Subsequently, as illustrated in FIG. 7, the rotating member is placed in the metal mold 41. In this process, the rotating member is positioned so that the axis of the shaft 4 extends along a horizontal direction. The metal mold 41 is divided into a first metal mold 42 in which a part of the rotating member including the commutator 10 is placed and a second metal mold 43 in which a part of the rotating member including the rotor 9 is placed. A mold parting face 44 between the first metal mold 42 and second metal mold 43 is positioned along a face of the flange 25 facing the brushes 15 and 16 after molding.

When the rotating member is placed in the metal mold 41, an end face 27 of the commutator 10 comes into contact with a reference face 45 of the first metal mold 42. Thus, a width L4 between the end face 27 of the commutator 10 and a portion of the first portion 20 covering the hooking portions 12 after molding is determined by the first metal mold 42. As a result, high accuracy and a small tolerance of the width L4 can be achieved. Namely, the accuracy of the width L1 of the gap 24 between the resin molded part 19 and the brushes 15 and 16 after molding is improved, and the tolerance of the width L1 can be made smaller.

Subsequently, molten resin is put into an inlet, which is not illustrated, of the metal mold 41. As a result, the molten resin is injected into the metal mold 41 through injection inlets 46 and 47 as shown by arrows III in FIG. 7.

At this stage, the injection inlet 46 of the first metal mold 42 is positioned in the side of the rotor 9 with respect to the commutator 10. In addition, the injection inlet 46 of the first metal mold 42 is formed so that the direction of injection of the molten resin is along the axial direction of the shaft 4. This configuration can prevent the molten resin from being directly injected to the hooking portions 12 and the crossover wires 14, so that disconnection of the crossover wires 14 caused by the injection pressure is prevented, and fusing of the hooking portions 12 is prevented from peeling off.

Subsequently, the rotating member molded with resin is taken out of the metal mold 41. In this process, the directions in which the first metal mold 42 and the second metal mold 43 are removed with respect to the rotating member are directions along the axial direction of the shaft 4.

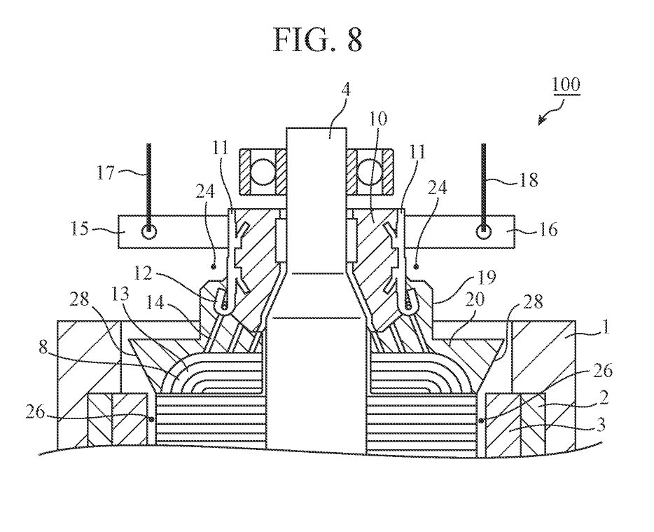

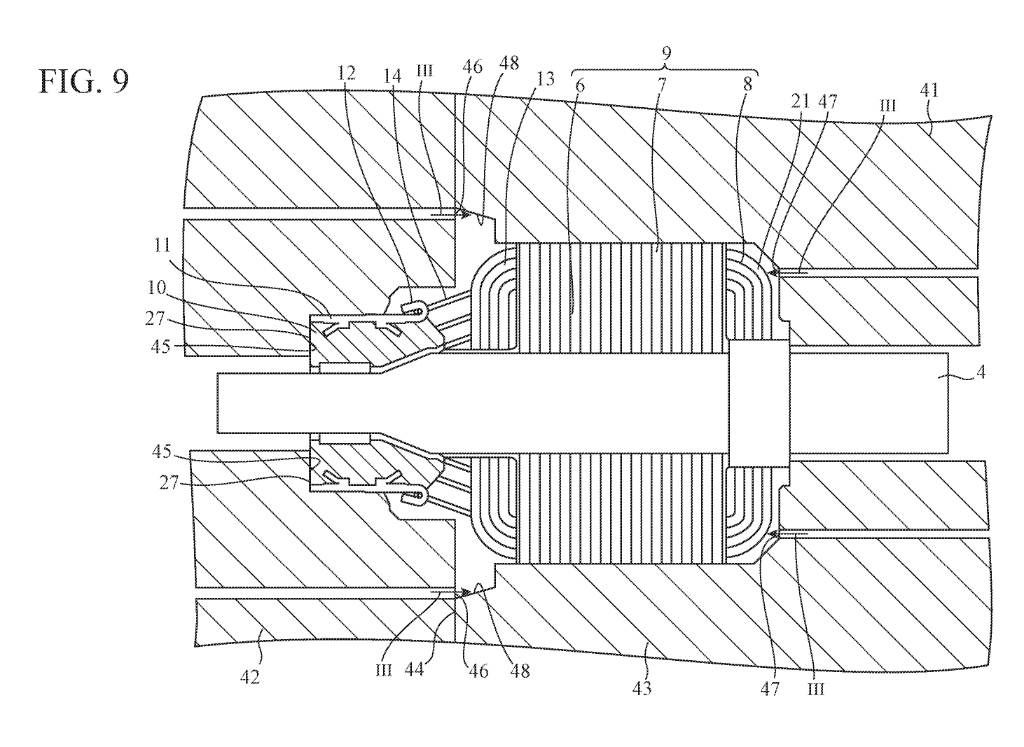

Note that the flange 25 of the resin molded part 19 may have a tapered face 28 around the outer circumference as illustrated in FIG. 8. The tapered face 28 is formed such that the diameter of the flange 25 gradually increases from the rotor 9 side toward the commutator 10 side. The tapered face 28 can be formed by providing a face with a draft angle 48 on the second metal mold 43 when the resin molded part 19 is molded as illustrated in FIG. 9. As a result, the structure of the metal mold 41 is simplified, and the number of manufacturing processes of the metal mold 41 can be reduced.

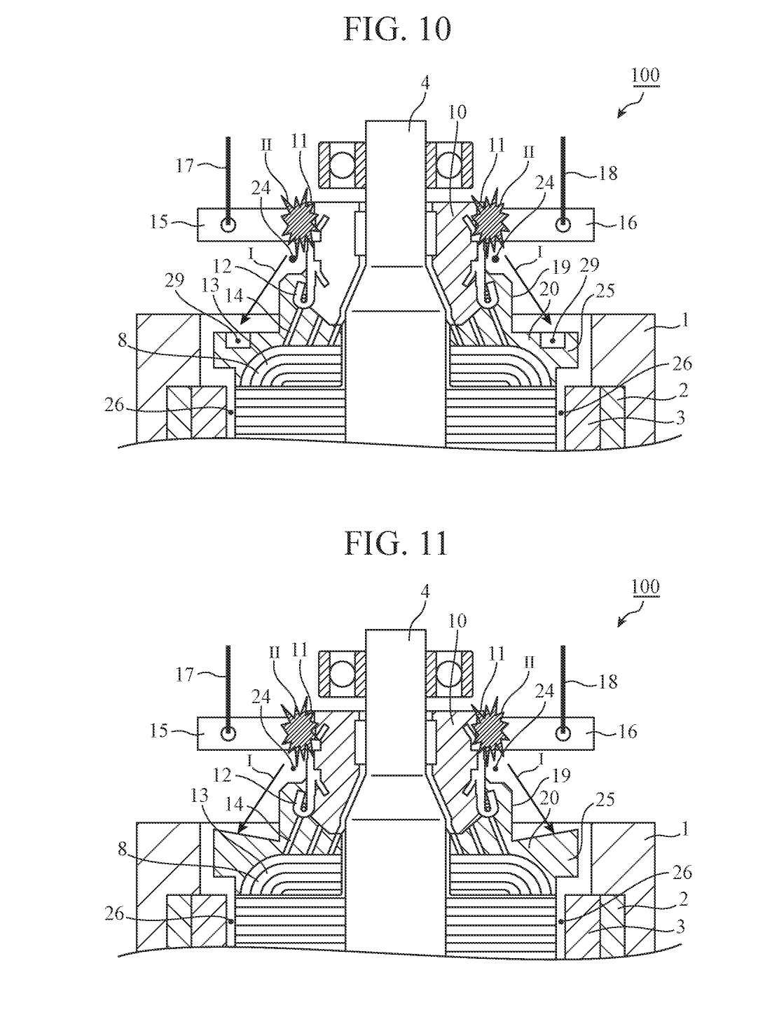

In addition, the flange 25 of the resin molded part 19 may have a receiving portion for receiving wear debris. The receiving portion can be formed by forming a groove 29 on a face of the flange 25 facing the commutator 10 as illustrated in FIG. 10, for example. Alternatively, the receiving portion can be formed by forming a face of the flange 25 facing the commutator 10 to be inclined as illustrated in FIG. 11.

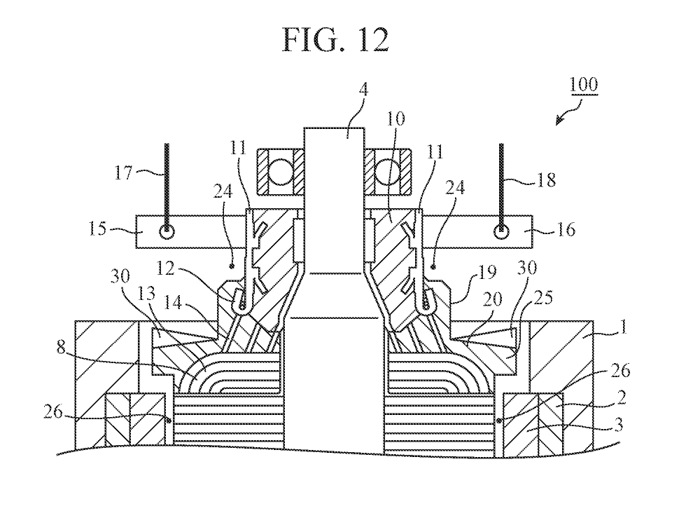

In addition, the flange 25 of the resin molded part 19 may have protrusions/recesses on a face facing the commutator 10. Specifically, fin-shaped protrusions/recesses 30 may be formed as illustrated in FIG. 12, for example. The protrusions/recesses formed on the flange 25 can make circulation of air in the brushed motor 100 when the rotor 9 is rotated. As a result, heat generated by sparks between the commutator 10 and the brushes 15 and 16, heat generated by energization of the coil 8, and the like are circulated, so that local heat increasing due to heat stagnation can be prevented.

In addition, the stator 1 may have any substantially cylindrical shape, and need not be exactly cylindrical. The meaning of the term “cylindrical” used in the claims of the present application covers not only exactly cylindrical shapes but also substantially cylindrical shapes.

As described above, a brushed motor 100 of the first embodiment includes: a shaft 4 inserted in a stator 1 having a cylindrical shape; a rotor 9 including a core 6 provided on an outer circumference of the shaft 4 to face the stator 1, and a coil 8 having a distributed winding structure wound around teeth 7 of the core 6; a commutator 10 provided on one end of the shaft 4, and electrically connected with the coil 8 by a wire drawn from coil end parts 13 of the coil 8; a resin molded part 19 covering the coil end parts 13, 21 and a hooking portion 12 for the wire of the commutator 10; and a brush 15, 16 being in contact with an outer circumference of the commutator 10. A width L1 of a gap 24 between the resin molded part 19 and the brush 15, 16 is set to a value larger than a scattering distance of a spark generated between the commutator 10 and the brush 15, 16. By setting the width L1 of the gap 24, the resin molded part 19 is prevented from being melted and deteriorated by heat of sparks. In addition, since the resin molded part 19 covers the coil end parts 13 and 21, collapse of winding at the coil end parts 13 and 21 is prevented. Furthermore, since the resin molded part 19 covers the hooking portions 12, the wires at the hooking portions 12 are fixed, so that disconnection of wires due to vibration can be prevented.

In addition, the resin molded part 19 includes a first portion 20 covering the hooking portions 12 and one coil end part 13 of the coil 8, a second portion 22 covering the other coil end part 21 of the coil 8, and a third portion 23 filling each space between adjacent teeth 7 and connected with the first portion 20 and the second portion 22. The third portion 23 increases the rigidity of the rotor 9, and as a result, deformation of the rotor 9 due to vibration can be prevented.

In the brushed motor 100, the outer circumferential surface of the third portion 23 is continuous with outer circumferential surfaces of the teeth 7. Thus, a gap 26 is formed between the part, formed by the outer circumference of the teeth 7 and the third portion 23, and the inner circumference of the stator 1, and as a result, it is possible to prevent the third portion 23 from being touched by the stator 1 while the rotor 9 rotates.

The resin molded part 19 has a flange 25 on the side of the commutator 10. By setting the diameter L2 of the flange 25 to a value larger than the inner diameter L3 of the stator 1, it is possible to prevent wear debris from entering the gap 26 between the rotor 9 and the stator 1, and failure of the bearing 5 can be prevented.

In the brushed motor 100, protrusions and recesses are formed on the face of the flange 25 facing the commutator 10. Due to such a configuration, heat generated by sparks between the commutator 10 and the brushes 15 and 16, heat generated by energization of the coil 8, and the like are circulated, and local heat increasing due to heat stagnation can be prevented.

In addition, a method for manufacturing a brushed motor 100 according to the first embodiment includes: a step of placing a member (a rotating member) formed by integrating the shaft 4, the rotor 9, and the commutator 10 in a metal mold 41; and a step of molding the resin molded part 19 by injection molding. The metal mold 41 (a first metal mold 42) comes into contact with an end face 27 of the commutator 10 when the member (the rotating member) is placed in the metal mold 41. Due to such a configuration, the accuracy of the width L1 of the gap 24 between the resin molded part 19 and the brushes 15 and 16 after molding is increased, and as a result, the tolerance of the width L1 can be made smaller.

Further, when molding of the resin molded part 19 is implemented, resin is injected into the metal mold 41 through the injection inlet 46 formed in the side of the rotor 9 with respect to the hooking portions 12. Due to such a configuration, the molten resin is prevented from being directly injected to the hooking portions 12 and the crossover wires 14, and it is possible to prevent disconnection of the crossover wires 14 caused by the injection pressure and fusing of the hooking portions 12 from peeling off.

Furthermore, in a method for manufacturing a brushed motor 100, the resin molded part 19 has a flange 25 on a side of the commutator 10, and the flange 25 has a tapered face 28 on an outer circumference thereof. The tapered face 28 is formed by providing a face with a draft angle 48 on the metal mold 41 (a second metal mold 43). As a result, the structure of the metal mold 41 is simplified, and the number of manufacturing processes of the metal mold 41 can be reduced.

Note that any components in any embodiments of the present invention can be modified, and any components in any embodiments can be omitted within the scope of the invention.

### INDUSTRIAL APPLICABILITY

A brushed motor for a vehicle according to the present invention can be used for a driving source for opening and closing a wastegate valve in a turbocharger or an exhaust gas recirculation (EGR) valve, for example.

### REFERENCE SIGNS LIST

1: Stator, 2: Yoke, 3: Magnet, 4: Shaft, 5: Bearing, 6: Core, 7: Teeth, 8: Coil, 9: Rotor, 10: Commutator, 11: Commutator piece, 12: Hooking portion, 13: Coil end part, 14: Crossover wire, 15, 16: Brush, 17, 18: Power supply terminal, 19: Resin molded part, 20: First portion, 21: Coil end part, 22: Second portion, 23: Third portion, 24: Gap, 25: Flange, 26: Gap, 27: End face, 28: Tapered face, 29: Groove, 30: Protrusions and recesses, 41: Metal mold, 42: First metal mold, 43: Second metal mold, 44: Mold parting face, 45: Reference face, 46, 47: Injection inlet, 48: Face with draft angle, 100: Brushed motor

1. A brushed motor for a vehicle, the brushed motor comprising:
a shaft inserted in a stator having a cylindrical shape;
a rotor including a core provided on an outer circumference of the shaft to face the stator, and a coil having a distributed winding structure wound around teeth of the core;
a commutator provided on one end of the shaft, and electrically connected with the coil by a wire drawn from coil end parts of the coil;
a resin molded part covering the coil end parts and a hooking portion for the wire of the commutator; and
a brush being in contact with an outer circumference of the commutator,
wherein a width of a gap between the resin molded part and the brush is set to a value larger than a scattering distance of a spark generated between the commutator and the brush.

2. The brushed motor for the vehicle according to claim 1, wherein the resin molded part includes a first portion covering the hooking portion and one of the coil end parts of the coil, a second portion covering another of the coil end parts of the coil, and a third portion filling spaces between the teeth adjacent to each other and connected with the first portion and the second portion.

3. The brushed motor for a vehicle according to claim 2, wherein an outer circumferential surface of the third portion is continuous with outer circumferential surfaces of the teeth.

4. The brushed motor for a vehicle according to claim 1, wherein the width of the gap is set to a value equal to or larger than 1 millimeter.

5. The brushed motor for a vehicle according to claim 1, wherein the resin molded part has a flange on a side of the commutator.

6. The brushed motor for a vehicle according to claim 5, wherein the flange has a diameter set to a value larger than an inner diameter of the stator.

7. The brushed motor for a vehicle according to claim 5, wherein the flange has a receiving portion receiving wear debris generated between the commutator and the brush.

8. The brushed motor for a vehicle according to claim 5, wherein the flange has a tapered face around an outer circumference of the flange.

9. The brushed motor for a vehicle according to claim 5, wherein the flange has protrusions and recesses on a face facing the commutator.

10. A method of manufacturing a brushed motor for a vehicle, the brushed motor including: a shaft inserted in a stator having a cylindrical shape; a rotor including a core provided on an outer circumference of the shaft to face the stator, and a coil having a distributed winding structure wound around teeth of the core; a commutator provided on one end of the shaft, and electrically connected with the coil by a wire drawn from coil end parts of the coil; a resin molded part covering the coil end parts and a hooking portion for the wire of the commutator; and a brush being in contact with an outer circumference of the commutator, wherein a width of a gap between the resin molded part and the brush is set to a value larger than a scattering distance of a spark generated between the commutator and the brush,
the method comprising:
a step of placing a member formed by integrating the shaft, the rotor, and the commutator in a metal mold; and
a step of molding the resin molded part by injection molding, wherein
the metal mold comes into contact with an end face of the commutator when the member is placed in the metal mold.

11. The method of manufacturing the brushed motor for a vehicle according to claim 10, wherein in the step of molding the resin molded part, resin is injected into the metal mold through an injection inlet formed in a side of the rotor with respect to the hooking portion.

12. The method of manufacturing the brushed motor for a vehicle according to claim 11, wherein in the step of molding the resin molded part, the resin is injected in a direction along an axial direction of the shaft.

13. The method of manufacturing the brushed motor for a vehicle according to claim 10, wherein
in the brushed motor for a vehicle, the resin molded part has a flange on a side of the commutator, and the flange has a tapered face on an outer circumference thereof, and
the tapered face is formed by providing a draft angle on the metal mold.
